(19) United States
(12) Patent Application Publication
(10) Pub. No.: US 2015/0207307 A1
(43) Pub. Date: Jul. 23, 2015

(54) BOOST APPARATUS WITH OVER-CURRENT AND OVER-VOLTAGE PROTECTION FUNCTION

(71) Applicant: Beyond Innovation Technology Co., Ltd., Taipei City (TW)

(72) Inventors: Chiu-Yuan Lin, Taipei City (TW); Ming-Chang Lee, Taipei City (TW); Chien-Pang Hung, Taipei City (TW)

(21) Appl. No.: 14/493,361

(22) Filed: Sep. 23, 2014

(30) Foreign Application Priority Data
Jan. 17, 2014 (TW) 103101773
Sep. 12, 2014 (TW) 103131540

(51) Int. Cl. H02H 3/00; H02H 7/12; H02M 3/156; H02M 1/36

(52) U.S. Cl. CPC H02H 3/00; H02M 1/36; H02H 7/1213; H02M 3/156

(57) ABSTRACT

A boost apparatus includes: a boost power conversion circuit having a first diode coupled to a load, and configured to receive a DC input voltage and provide a DC output voltage to the load in response to a pulse-width-modulation (PWM) signal; a complex function detection circuit coupled to an anode of the first diode and configured to detect whether the DC output voltage is over-voltage and detect whether the first diode is open-circuit and accordingly provide a detection signal; and a control chip configured to: generate the PWM signal to control the operation of the boost power conversion circuit; and stop outputting the PWM signal and enter a shutdown status in response to the detection signal when the first diode is open-circuit or the DC output voltage is over-voltage, thereby protecting the boost apparatus and/or the load from damaging.

### CROSS-REFERENCE TO RELATED APPLICATION

This application claims the priority benefits of Taiwan application serial no. 103101773, filed on Jan. 17, 2014 and Taiwan application serial no. 103131540, filed on Sep. 12, 2014. The entirety of each of the above-mentioned patent applications is hereby incorporated by reference herein and made a part of this specification.

### BACKGROUND OF THE INVENTION

1. Field of the Invention

The invention relates to power conversion and supply technology and more particularly relates to a boost apparatus having over-current and over-voltage protection functions.

2. Description of Related Art

The current PWM-based boost apparatus may be configured to provide DC output voltage to the load. When a diode at the output side (or output end) in the boost apparatus is open-circuit, however, the power switch on the power switching path in the boost apparatus may be damaged (short circuit, for example), which results in damaging the internal components of the boost apparatus and/or the load, or causing power short circuit and damage to the system using the boost apparatus.

### SUMMARY OF THE INVENTION

Accordingly, the invention provides a boost apparatus adapted for or capable of detecting whether a diode at an output side (or output end) is open-circuit, thereby effectively solving the problems that the prior art is facing.

Details of other features and advantages of the invention may be understood through this disclosure.

Here, an exemplary embodiment of the invention provides a boost apparatus adapted for providing a DC output voltage to a load, and the boost apparatus includes: a boost power conversion circuit, a complex function detection circuit, and a control chip. The boost power conversion circuit includes a first diode (disposed/located at an output side/output end of the boost apparatus) coupled to the load and configured to receive a DC input voltage and provide the DC output voltage to the load in response to a pulse-width-modulation (PWM) signal. The complex function detection circuit is coupled to an anode of the first diode and configured to detect whether the DC output voltage is over-voltage and detect whether the first diode is open-circuit and provide a detection signal accordingly. The control chip is coupled to the boost power conversion circuit and the complex function detection circuit and configured to: generate the pulse-width-modulation signal to control an operation of the boost power conversion circuit; and stop outputting the pulse-width-modulation signal and enter a shutdown status in response to the detection signal when the first diode is open-circuit or the DC output voltage is over-voltage, thereby protecting the boost apparatus and/or the load from damaging.

In an exemplary embodiment of the invention, the boost power conversion circuit further includes: an inductor, a first capacitor, an N-type power switch, and a first resistor. A first end of the inductor is configured to receive the DC input voltage and a second end of the inductor is coupled to the anode of the first diode, and a cathode of the first diode is coupled to the load and provides the DC output voltage to the load. A first end of the first capacitor is coupled to the cathode of the first diode, and a second end of the first capacitor is coupled to a ground potential. A drain of the N-type power switch is coupled to the anode of the first diode, and a gate of the N-type power switch is configured to receive the pulse-width-modulation signal. A first end of the first resistor is coupled to a source of the N-type power switch, and a second end of the first resistor is coupled to the ground potential.

In an exemplary embodiment of the invention, the complex function detection circuit includes: a second diode, a second capacitor, a second resistor, and a third resistor. An anode of the second diode is coupled to the anode of the first diode. A first end of the second capacitor is coupled to a cathode of the second diode, and a second end of the second capacitor is coupled to the ground potential. A first end of the second resistor is coupled to the cathode of the second diode, and a second end of the second resistor is configured to provide the detection signal. A first end of the third resistor is coupled to the second end of the second resistor, and a second end of the third resistor is coupled to the ground potential.

In an exemplary embodiment of the invention, the control chip includes/has a built-in predetermined over-voltage protection reference voltage and an over-voltage protection detection pin coupled to the first end of the third resistor. Under this condition, if the DC output voltage is over-voltage and/or the first diode is open-circuit, a voltage of the detection signal is higher than the predetermined over-voltage protection reference voltage, so as to cause the control chip to stop outputting the pulse-width-modulation signal and enter the shutdown status.

In an exemplary embodiment of the invention, the control chip includes/has a built-in predetermined over-current protection reference voltage and an over-current protection detection pin coupled to the first end of the first resistor. Under this condition, if a current flowing through the first resistor is over-current, a cross voltage of the first resistor is higher than the predetermined over-current protection reference voltage, so as to cause the control chip to stop outputting the pulse-width-modulation signal at a current duty cycle and to resume outputting the pulse-width-modulation signal at a next duty cycle.

Based on the above, if the first diode at the output side/output end is open-circuit or the DC output voltage is over-voltage, the boost apparatus of the invention causes the control chip to enable the protection mechanism to stop outputting the PWM signal, used for controlling the operation of the boost power conversion circuit, and enter the shutdown status. Accordingly, damage, such as short circuit, caused by the N-type power switch on a power switching path is avoided to prevent damaging internal components of the boost apparatus and/or the load, or prevent causing power short circuit and damage to the system using the boost apparatus.

To make the aforementioned and other features and advantages of the invention more comprehensible, several embodiments accompanied with drawings are described in detail as follows.

However, it is to be understood that both the foregoing general descriptions and the following specific embodiments are exemplary and are not intended to limit the scope of the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a system block diagram of a boost apparatus 10 according to an exemplary embodiment of the invention.

FIG. 2 is an implementation diagram of the boost apparatus 10 in FIG. 1.

### DESCRIPTION OF THE EMBODIMENTS

Descriptions of the invention are given with reference to the exemplary embodiments illustrated by the drawings. In addition, wherever possible, identical or similar reference numerals stand for identical or similar elements/components in the drawings and embodiments.

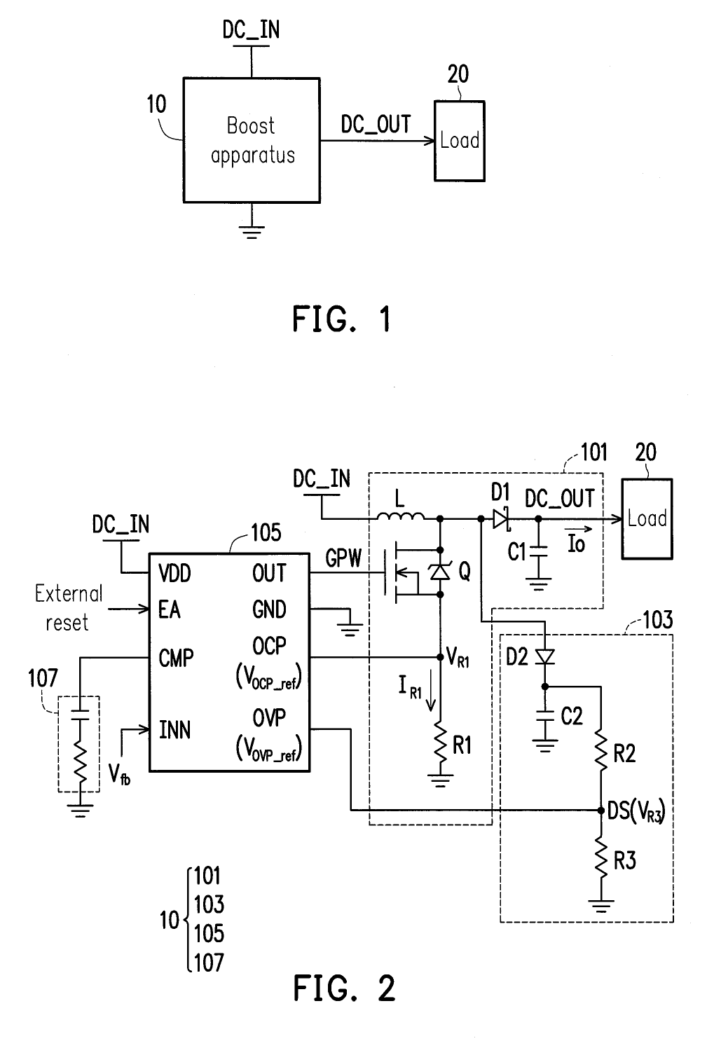

FIG. 1 is a system block diagram of a boost apparatus 10 according to an exemplary embodiment of the invention. FIG. 2 is an implementation diagram of the boost apparatus 10 in FIG. 1. With reference to FIG. 1 and FIG. 2, the boost apparatus 10 is adapted for providing a DC output voltage DC_OUT to a load 20 of any type. The boost apparatus 10 includes: a boost power conversion circuit 101, a complex function detection circuit 103, a control chip 105, and a resistor-capacitor (RC) network 107.

In this exemplary embodiment, the boost power conversion circuit 101 is configured to receive a DC input voltage DC_IN and provide the DC output voltage DC_OUT to the load 20 in response to a pulse-width-modulation signal (PWM signal) GPW from the control chip 105. For example, the boost power conversion circuit 101 includes: a diode D1 (e.g. a Schottky diode at an output side/output end of the boost apparatus 10, but not limited thereto) coupled to the load 20, an inductor L, a capacitor C1, an N-type power switch Q, and a resistor R1. The N-type power switch Q may be implemented by an N-type power MOSFET, but the invention is not limited thereto. Moreover, in other exemplary embodiments of the invention, the N-type power switch Q is not necessarily disposed in the boost power conversion circuit 101. In other words, the N-type power switch Q may be integrated into the control chip 105 depending on the actual requirements of design/application.

A first end of the inductor L is configured to receive (or coupled to) the DC input voltage DC_IN, and a second end of the inductor L is coupled to an anode of the diode D1. A cathode of the diode D1 is coupled to the load 20 and provides the DC output voltage DC_OUT to the load 20. A first end of the capacitor C1 is coupled to the cathode of the diode D1, and a second end of the capacitor C1 is coupled to a ground potential (0V). A drain of the N-type power switch Q is coupled to the anode of the diode D1, and a gate of the N-type power switch Q is configured to receive the PWM signal GPW outputted by the control chip 105. A first end of the resistor R1 is coupled to a source of the N-type power switch Q, and a second end of the resistor R1 is coupled to the ground potential.

In addition, the complex function detection circuit 103 is coupled to the anode of the diode D1, and the complex function detection circuit 103 is configured to detect whether the DC output voltage DC_OUT is over-voltage and detect whether the diode D1 is open-circuit and provide a detection signal DS accordingly. For example, the complex function detection circuit 103 includes: a diode D2, a capacitor C2, and resistors R2 and R3. An anode of the diode D2 is coupled to the anode of the diode D1. A first end of the capacitor C2 is coupled to a cathode of the diode D2, and a second end of the capacitor C2 is coupled to the ground potential. A first end of the resistor R2 is coupled to the cathode of the diode D2, and a second end of the resistor R2 is configured to provide the detection signal DS. A first end of the resistor R3 is coupled to the second end of the resistor R2, and a second end of the resistor R3 is coupled to the ground potential.

Furthermore, the control chip 105 may include a plurality of pins, such as a power pin VDD, a ground pin GND, a chip enable pin EA, an output pin OUT, an over-current protection detection pin OCP, an over-voltage protection detection pin OVP, a feedback pin INN, and a compensation pin CMP. Depending on the actual requirements of design/application, surely other functional pins can be added to the control chip 105, or some existing functional pins can be removed from the control chip 105. Basically, in order that the control chip 105 can operate normally, the power pin VDD receives the DC input voltage DC_IN required for the operation, and the ground pin GND is coupled to the ground potential. Accordingly, the control chip 105 is capable of converting (e.g. boosting/bucking) the DC input voltage DC_IN, so as to obtain operating voltage(s) required by internal circuit(s) (not shown).

In this exemplary embodiment, the control chip 105 is coupled to the boost power conversion circuit 101 and the complex function detection circuit 103, and is configured to: generate the PWM signal GPW and output the PWM signal GPW through the output pin OUT coupled to the gate of the N-type power switch Q to control an operation of the boost power conversion circuit 101; and stop outputting the PWM signal GPW and enter a shutdown (inactivation) status in response to the detection signal DS of the complex function detection circuit 103 when the diode D1 is open-circuit or when the DC output voltage DC_OUT is over-voltage, thereby protecting the boost apparatus 10 and/or the load 20 from damaging.

To be more specific, a predetermined OCP reference voltage Vocp_ref and a predetermined OVP reference voltage Vovp_ref may be built in the control chip 105, and the over-current protection detection pin OCP and the over-voltage protection detection pin OVP of the control chip 105 are respectively coupled to the first ends of the resistors R1 and R3.

In this exemplary embodiment, when a current I_{R1} that flows through the resistor R1 is over-current, a cross voltage V_{R1} of the resistor R1 is higher than the predetermined OCP reference voltage Vocp_ref built in the control chip 105. Under this condition, the control chip 105 immediately stops outputting the PWM signal GPW at a current duty cycle to enable/activate an over-current protection mechanism, so as to protect the boost apparatus 10 and/or the load 20 from damaging due to influence of over-current. Then, the control chip 105 would resume outputting the PWM signal GPW at the next duty cycle.

In addition, based on the implementation of the complex function detection circuit 103, it is clear that the diode D2 and the capacitor C2 are configured to store a voltage corresponding to the DC output voltage DC_OUT; and the resistors (R2, R3) are configured to divide the stored voltage, so as to generate and provide the detection signal DS. Under this condition, when the DC output voltage DC_OUT is over-voltage and/or when the diode D1 is open-circuit, a voltage (i.e. a cross voltage V_{R3} of the resistor R3) of the detection signal DS of the complex function detection circuit 103 is higher than the predetermined OVP reference voltage Vovp_ref. Therefore, the control chip 105 stops outputting the PWM signal GPW to enable an over-voltage protection mechanism. Meanwhile, the control chip 105 also enters the shutdown status, so as to protect the boost apparatus 10 and/or the load 20 from damaging due to influence of abnormal high voltage/over-voltage. It should be noted that, if the load 20 is an LED load, the over-voltage of the DC output voltage DC_OUT may occur when the LED load is open-circuit or may be caused by other improper circuit operations. Thus, the complex function detection circuit 103 has both the functions of LED load open protection and diode Dl open protection.

Further, in other exemplary embodiments of the invention, if the over-voltage protection mechanism is designed individually, a dividing circuit (not shown), which is formed of two series-connected resistors for example, may be disposed between the cathode of the diode D1 and the ground potential, and an obtained dividing signal may be provided to the over-voltage detection pin OVP of the control chip 105, thereby achieving the over-voltage protection mechanism individually.

Moreover, in order to maintain the stability of the boost apparatus 10, in this exemplary embodiment, the RC network 107 (e.g. series-connected resistor and capacitor, but not limited thereto) may be coupled to the compensation pin CMP of the control chip 105 (or disposed between the compensation pin CMP of the control chip 105 and the ground potential). In actual application, the RC network 107 may be configured to stabilize the PWM signal GPW outputted by the control chip 105, so as to stabilize the DC output voltage DC_OUT provided by the boost power conversion circuit 101. Further, the control chip 105 may receive a feedback voltage V_{fb} associated with the load 20 through the feedback pin INN, so as to adjust the PWM signal GPW outputted from the control chip 105, and thereby changing a DC output current Io of the boost apparatus 10 (P.S. if the load 20 is an LED load, then the DC output voltage DC_OUT would be clamped to a predetermined value/set value/given value, such that the DC output current Io of the boost apparatus 10 increases as the duty cycle of the PWM signal GPW increases, and decreases as the duty cycle of the PWM signal GPW decreases).

In addition, once the control chip 105 enters the shutdown status in response to the open-circuit of the diode D1 or the over-current or over-voltage phenomenon, the control chip 105 may be reset through the chip enable pin EA of the control chip 105 from the external, thereby restoring the control chip 105 from the shutdown (inactivation) status to an activation status.

To sum up, if the diode D1 at the output side/output end is open-circuit or the DC output voltage DC_OUT is over-voltage, the boost apparatus 10 of the invention causes the control chip 105 to enable the protection mechanism to stop outputting the PWM signal, used for controlling the operation of the boost power conversion circuit 101, and enter the shutdown status. Accordingly, damage, such as short circuit, caused by the N-type power switch Q on a power switching path is avoided to prevent damaging internal components of the boost apparatus 10 and/or the load 20, or prevent causing power short circuit and damage to the system using the boost apparatus 10.

It is worth mentioning that, if the load 20 is the LED load, the boost apparatus 10 is applicable to backlight driving in the field of LCD. In addition, if the load 20 is a circuit system load, the boost apparatus 20 is applicable to constant voltage supply in the field of power conversion. Nevertheless, application of the boost apparatus 10 provided in the exemplary embodiment is not limited to the above.

Although the invention has been described with reference to the above exemplary embodiments, it will be apparent to those skilled in the art that modifications to the described embodiments may be made without departing from the spirit of the invention. Accordingly, the scope of the invention will be defined by the attached claims not by the above detailed descriptions.

Any of the embodiments or any of the claims of the invention does not necessarily achieve all of the advantages or features disclosed by the invention. Moreover, the abstract and the title are merely used to aid in search of patent files and are not intended to limit the scope of the claims of the invention.

What is claimed is:

1. A boost apparatus adapted for providing a DC output voltage to a load, the boost apparatus comprising:
a boost power conversion circuit comprising a first diode coupled to the load and configured to receive a DC input voltage and provide the DC output voltage to the load in response to a pulse-width-modulation signal;
a complex function detection circuit coupled to an anode of the first diode and configured to detect whether the DC output voltage is over-voltage and detect whether the first diode is open-circuit and provide a detection signal accordingly; and
a control chip coupled to the boost power conversion circuit and the complex function detection circuit and configured to: generate the pulse-width-modulation signal to control an operation of the boost power conversion circuit, and stop outputting the pulse-width-modulation signal and enter a shutdown status in response to the detection signal when the first diode is open-circuit or when the DC output voltage is over-voltage, so as to protect the boost apparatus and/or the load from damaging.

2. The boost apparatus according to claim 1, wherein the boost power conversion circuit further comprises:
an inductor having a first end receiving the DC input voltage and a second end coupled to the anode of the first diode, wherein a cathode of the first diode is coupled to the load and provides the DC output voltage to the load;
a first capacitor having a first end coupled to the cathode of the first diode and a second end coupled to a ground potential;
an N-type power switch having a drain coupled to the anode of the first diode and a gate receiving the pulse-width-modulation signal; and
a first resistor having a first end coupled to a source of the N-type power switch and a second end coupled to the ground potential.

3. The boost apparatus according to claim 2, wherein the first diode is a Schottky diode.

4. The boost apparatus according to claim 2, wherein the N-type power switch is capable of being integrated in the control chip.

5. The boost apparatus according to claim 2, wherein the complex function detection circuit comprises:
a second diode having an anode coupled to the anode of the first diode;
a second capacitor having a first end coupled to a cathode of the second diode and a second end coupled to the ground potential;
a second resistor having a first end coupled to the cathode of the second diode and a second end providing the detection signal; and
a third resistor having a first end coupled to the second end of the second resistor and a second end coupled to the ground potential.

6. The boost apparatus according to claim 5, wherein:
the control chip has a built-in predetermined over-voltage protection reference voltage and an over-voltage protection detection pin coupled to the first end of the third resistor; and
if the DC output voltage is over-voltage and/or the first diode is open-circuit, a voltage of the detection signal is higher than the predetermined over-voltage protection reference voltage, so as to cause the control chip to stop outputting the pulse-width-modulation signal and enter the shutdown status.

7. The boost apparatus according to claim 2, wherein:
the control chip has a built-in predetermined over-current protection reference voltage and an over-current protection detection pin coupled to the first end of the first resistor; and
if a current flowing through the first resistor is over-current, a cross voltage of the first resistor is higher than the predetermined over-current protection reference voltage, so as to cause the control chip to stop outputting the pulse-width-modulation signal at a current duty cycle and to resume outputting the pulse-width-modulation signal at a next duty cycle.

8. The boost apparatus according to claim 2, wherein the control chip has an output pin coupled to the gate of the N-type power switch to output the pulse-width-modulation signal.

9. The boost apparatus according to claim 2, wherein: the control chip has a power pin to receive the DC input voltage required for operation; and the control chip further has a ground pin to be coupled to the ground potential.

10. The boost apparatus according to claim 1, wherein the control chip has a compensation pin, and the boost apparatus further comprises:
a resistor-capacitor (RC) network coupled to the compensation pin and configured to cause the boost power conversion circuit to stably provide the DC output voltage.

11. The boost apparatus according to claim 1, wherein the control chip has a feedback pin to receive a feedback voltage associated with the load, so as to adjust the pulse-width-modulation signal and thus changing a DC output current of the boost apparatus.

12. The boost apparatus according to claim 1, wherein the control chip has a chip enable pin for resetting the control chip and restoring the control chip from the shutdown status to an activation status from the external.
